(19) United States
(12) Patent Application Publication
(10) Pub. No.: US 2008/0146682 A1
(43) Pub. Date: Jun. 19, 2008

(54) Production of Liquid and, Optionally, Gaseous Products from Gaseous Reactants

(76) Inventor: Andre Peter Steynberg, Gauteng Province (ZA)

Correspondence Address: FITCH EVEN TABIN AND FLANNERY, 120 SOUTH LA SALLE STREET, SUITE 1600, CHICAGO, IL, 60603-3406, US

(21) Appl. No.: 11/908,713

(22) PCT Filed: Mar. 17, 2006
(86) PCT No.: PCT/IB2006/050837

§ 371 Date: Sep. 14, 2007

(30) Foreign Application Priority Data
Mar. 17, 2005 (ZA) 2005/02265

(51) Int. Cl. C10G 2/00; B01J 8/22

(52) U.S. Cl. 518/700; 422/146

(57) ABSTRACT

A process for producing liquid and, optionally, gaseous products from gaseous reactants includes feeding at a low level gaseous reactants into a vertically extending slurry bed of solid particles suspended in a suspension liquid, the slurry bed being located around a plurality of vertically extending jacketed conduits each comprising an inner conduit and an outer or jacket conduit defining between them a jacket space and the slurry bed also being located inside the inner conduits. The gaseous reactants are allowed to react exothermically as they pass upwardly through the slurry bed, thereby to form liquid and, optionally, gaseous products, and with the liquid product forming together with the suspension liquid, a liquid phase of the slurry bed, the reactions thus taking place outside the jacketed conduits and inside the inner conduits. A cooling medium is passed through the jacket spaces thereby to remove reaction heat from the slurry bed.

THIS INVENTION relates to the production of liquid and, optionally, gaseous products from gaseous reactants. In particular, the invention relates to a process for producing liquid and, optionally, gaseous products from gaseous reactants and to an installation for producing liquid and, optionally, gaseous products from gaseous reactants.

Slurry phase reactors are advantageously used for highly exothermic reactions due to their excellent heat transfer properties and the reduced risk of forming hot spots in the slurry phase. However, modern catalysts are increasingly more active resulting in a higher rate of heat release per reactor volume. There is thus a need for higher heat removal capacity in slurry phase reactors.

According to one aspect of the invention, there is provided a process for producing liquid and, optionally, gaseous products from gaseous reactants, the process including
feeding at a low level gaseous reactants into a vertically extending slurry bed of solid particles suspended in a suspension liquid, the slurry bed being located around a plurality of vertically extending jacketed conduits each comprising an inner conduit and an outer or jacket conduit defining between them a jacket space and the slurry bed also being located inside the inner conduits;
allowing the gaseous reactants to react exothermically as they pass upwardly through the slurry bed, thereby to form liquid and, optionally, gaseous products, and with the liquid product forming together with the suspension liquid, a liquid phase of the slurry bed, the reactions thus taking place outside the jacketed conduits and inside the inner conduits;
passing a cooling medium through the jacket space of the jacketed conduits thereby to remove reaction heat from the slurry bed;
allowing gaseous product and unreacted gaseous reactants to disengage from the slurry bed into a head space above the slurry bed;
withdrawing gaseous product and unreacted gaseous reactants from the head space; and
withdrawing liquid phase or slurry from the slurry bed, to maintain the slurry bed at a desired level.

The cooling medium may be boiler feed water, the process thus also providing hot pressurised boiler feed water which can be used to produce steam.

The inner conduits of the jacketed conduits are typically all open-ended, with at least bottom open ends being located within the slurry bed.

Heat transfer surfaces defined by the jacketed conduits may be shaped or textured to increase their heat transfer surface area or to improve heat transfer coefficients, compared to that obtained using smooth cylindrical surfaces only. The shaping or texturing may include, amongst other methods known to persons skilled in the art, the use of dimpled, ribbed or finned surfaces.

The process preferably includes allowing slurry to pass downwardly from a high level in the slurry bed to a lower level thereof, using slurry redistribution means or slurry redistributors, thereby to redistribute solid particles within the slurry bed.

While it is believed that the process can, at least in principle, have broader application, it is envisaged that the solid particles will normally be catalyst particles for catalyzing the reaction of the gaseous reactants into the liquid product and, when applicable, the gaseous product; and the suspension liquid will normally, but not necessarily always, include the liquid product.

Furthermore, while it is also believed that, in principle, the process can have broader application, it is envisaged that it will have particular application in hydrocarbon synthesis where the gaseous reactants are capable of reacting catalytically exothermically in the slurry bed to form liquid hydrocarbon product and, optionally, gaseous hydrocarbon product. In particular, the hydrocarbon synthesis may be Fischer-Tropsch synthesis, with the gaseous reactants being in the form of a synthesis gas stream comprising mainly carbon monoxide and hydrogen, and with both liquid and gaseous hydrocarbon products being produced.

The process may include cooling the gas from the head space to condense liquid product, e.g. liquid hydrocarbons and reaction water, separating the liquid product from the gases to provide a tail gas, and recycling at least some of the tail gas to the slurry bed as a recycle gas stream.

The slurry bed may thus be contained or provided in a reaction zone of a vessel in the form of a slurry reactor or bubble column. The slurry reactor or bubble column thus uses a three-phase system, i.e. solid catalyst particles, liquid product, and gaseous reactants (including any recycled gas) and, optionally, gaseous product and inert gases.

The catalyst of the catalyst particles can be any desired Fischer-Tropsch catalyst, such as an iron-based catalyst, a cobalt-based catalyst, or any other Fischer-Tropsch catalyst. The catalyst particles may have a desired particle size range, e.g. no catalyst particles greater than 300 microns and less than 5% by mass of the catalyst particles being smaller than 22 microns.

The slurry reactor or bubble column may thus be maintained at normal elevated pressure and temperature conditions associated with Fischer-Tropsch synthesis reactions, e.g. a predetermined operating pressure in the range 10 to 50 bar, and a predetermined temperature in the range 160° C. to 280° C., or even higher for the production of lower boiling point product.

The catalyst particles in the slurry bed are thus maintained in suspension by the turbulence created by the synthesis gas stream (fresh and any optional recycled gas) passing through the slurry bed, i.e. bubbling through the slurry bed. The gas velocity through the slurry bed is thus sufficiently high to maintain the slurry bed in a state of turbulence or suspension.

According to another aspect of the invention, there is provided an installation for producing liquid and, optionally, gaseous products from gaseous reactants, the installation including
a reactor vessel having a vertically extending slurry bed zone which, in use, will contain a slurry bed of solid particles suspended in a suspension liquid;
a gas inlet in the vessel at a low level within the slurry bed zone, for introducing gaseous reactants into the vessel;
a gas outlet in the vessel above the slurry bed zone, for withdrawing gas from a head space above the slurry bed zone;
a liquid outlet in the vessel within the slurry bed zone, for withdrawing liquid product or slurry from the vessel; and
a plurality of vertically extending jacketed conduits in the slurry bed zone, each jacketed conduit comprising an inner conduit and an outer or jacket conduit defining between them a jacket space, the jacket space of at least some of the jacketed conduits being in flow communication to receive a common heat transfer fluid and to discharge the common heat transfer fluid, the inner conduits being open-ended in use to allow the slurry bed to occupy the inner conduits, and an external surface of the outer conduits being exposed to the slurry bed zone in use to be in contact with the slurry bed.

At least bottom open ends of the inner conduits are thus located within the slurry bed zone. Upper open ends of the inner conduits may be located within the slurry bed zone or may protrude above the slurry bed zone into the head space.

The inner and outer conduits are preferably circular cylindrical and are preferably concentric. Thus, the jacket space of a jacketed conduit is typically annular in transverse section.

Heat transfer surfaces defined by the jacketed conduits may be shaped or textured to increase their heat transfer surface area or to improve heat transfer coefficients, compared to that obtained using smooth cylindrical surfaces only. The shaping or texturing may include, amongst other methods known to persons skilled in the art, the use of dimpled, ribbed or finned surfaces.

Preferably, the inner conduits have an inner diameter of at least about 5 cm, more preferably at least about 7.5 cm, e.g. between about 7 cm and about 16 cm.

Preferably, the outer conduits have an outer diameter of at least about 7 cm, more preferably at least about 10 cm, e.g. between about 10 cm and about 22 cm.

Preferably at least two bundles of jacketed conduits are positioned within the slurry bed, with the bundles being vertically spaced. Designs with a single bundle of jacketed conduits are also possible.

The jacketed conduits, or the vertically spaced bundles of jacketed conduits when combined, may have a length equal to at least about 50% of the height of the slurry bed zone, preferably at least about 60%, e.g. between about 65% and about 80% of the height of the slurry bed zone.

The jacketed conduits may be arranged and dimensioned to provide between about 10 m² and about 50 m² of heat transfer surface area per m³ of slurry bed zone, preferably between about 12 m² and about 15 m² of heat transfer surface area per m³ of slurry bed zone, e.g. about 13 m² of heat transfer surface area per m³ of slurry bed zone.

Typically, for a commercial scale Fischer-Tropsch synthesis installation, at least the majority of the jacketed conduits each provide a heat transfer surface area of at least 0.38 m²/m, preferably at least about 0.55 m²/m, e.g. about 0.85 m²/m.

Preferably, the installation includes slurry redistribution means or one or more slurry redistributors through which, in use, slurry can be redistributed from a high level in the slurry bed to a lower level thereof, thereby to redistribute solid particles in the slurry bed.

In this specification, the term “slurry redistribution means” is intended to refer to physical apparatus used to redistribute slurry and catalyst particles vertically inside the reactor vessel, and does not refer to the slurry and catalyst particle redistribution action of the gas passing upwards through the slurry bed. The slurry redistribution means or slurry redistributors may thus include downcomers or draught tubes or mechanical redistribution apparatus such as pipes and pumps and filters.

The invention will now be described in more detail with reference to the accompanying drawings, in which

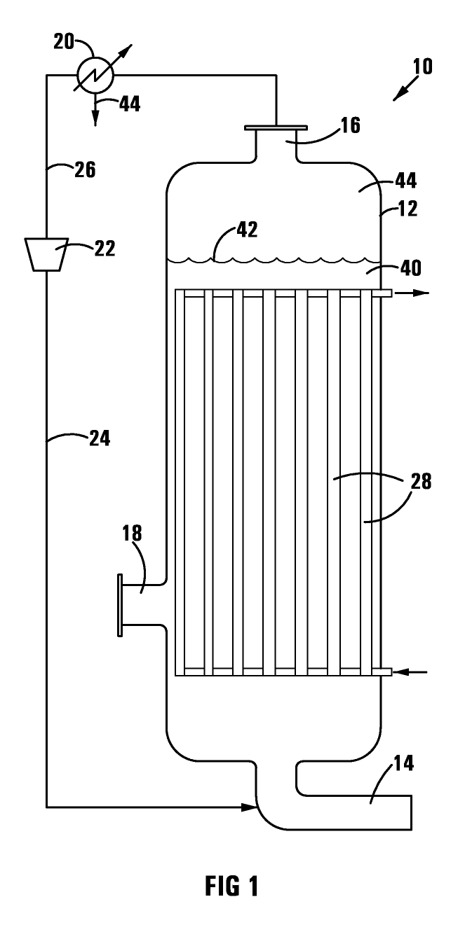

FIG. 1 shows schematically a longitudinal sectional view of an installation in accordance with the invention for producing liquid and gaseous products from gaseous reactants;

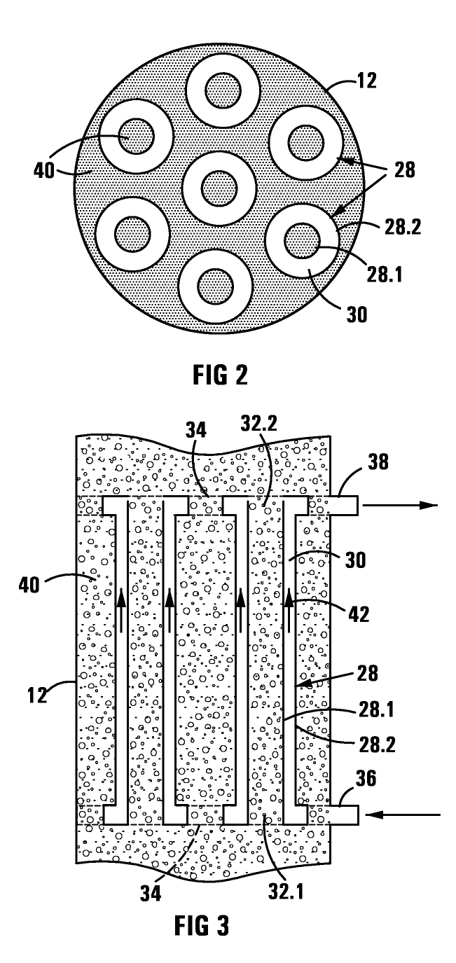

FIG. 2 shows a horizontal section through the slurry bubble column of the installation of FIG. 1, with parts omitted and parts exaggerated in size for clarity; and

FIG. 3 shows schematically a longitudinal sectional view of part of the slurry bubble column of the installation of FIG. 1, again with parts omitted and parts exaggerated in size for clarity.

Referring to FIG. 1 of the drawings, reference numeral 10 generally indicates an installation according to the invention for producing liquid and gaseous products from gaseous reactants.

The installation 10 includes an upright circular cylindrical slurry reactor or bubble column 12 with a bottom gas inlet 14 leading into a gas distributor (not shown) inside the reactor 12 and a gas outlet 16 leading from the top of the reactor 12. A liquid product outlet 18 leads from the reactor 12 at any convenient level.

Although not shown in the drawings, the reactor 12 typically includes one or more downcomer regions, each downcomer region including at least one downcomer. Typically, the downcomer includes a cylindrical transport section of relatively small diameter, an outwardly flaring connecting component at an upper end of the transport section, and a large diameter degassing section, a lower end of which is connected to the connecting component. An upper end of a degassing section thus provides an inlet for slurry, while a lower end of the transport section provides a slurry outlet.

The downcomer regions are typically vertically spaced, with the lower end of the downcomer of the upper downcomer region being spaced with vertical clearance from the upper end of the downcomer of the lower downcomer region. Furthermore, the downcomer of the upper downcomer region is usually not aligned axially with the downcomer of the lower downcomer region. In other words, the downcomer of the upper region is staggered relative to the downcomer of the lower region when the reactor 12 is seen in plan view.

The installation 10 further includes a separation unit 20 in flow communication with the gas outlet 16 and a compressor 22 in flow communication with the separation unit 20. A recycle gas stream line 24 leads from the compressor 22, with a tail gas line 26 establishing flow communication between the separation unit 20 and the compressor 22.

A plurality of vertically extending jacketed conduits 28 is located inside the bubble column or reactor 12. Each jacketed conduit 28 includes an inner conduit 28.1 and an outer or jacket conduit 28.2, as can be clearly seen in FIGS. 2 and 3 of the drawings. The inner conduits 28.1 and the outer conduits 28.2 are circular cylindrical or tubular and the inner conduit 28.1 and the outer conduit 28.2 of each jacketed conduit 28 are concentric. Between the inner conduit 28.1 and the outer conduit 28.2 of each jacketed conduit 28, an annular in transverse section jacket space 30 is thus defined.

The jacketed conduits 28 are disposed across the cross-section of the reactor 12 as shown in FIG. 2 of the drawings. However, as will be appreciated, the arrangement of the jacketed conduits 28 over the cross-section of the reactor 12 can be in any fashion as desired, e.g. to provide more heat transfer area in particular areas of the reactor 12 or to provide for downcomers in some areas of the reactor 12.

Heat transfer surfaces of the conduits 28.1 and 28.2 may optionally be shaped or textured to increase their heat transfer surface area or to improve heat transfer coefficients. The shaping or texturing may include, amongst other methods known to persons skilled in the art, the use of dimpled, ribbed or finned conduits.

Vertically spaced ends 32.1, 32.2 of the inner conduits 28.1 are open. In contrast, the vertically spaced ends of the outer or jacket conduits 28.2 are closed, but the jacket spaces 30 of the jacketed conduits 28 are connected at their lower ends and at their upper ends by conduits 34. A boiler feed water inlet 36 and a boiler feed water outlet 38 are in flow communication with the conduits 34 to allow boiler feed water to be circulated through the jacket spaces 30.

In use, fresh synthesis gas comprising mainly carbon monoxide and hydrogen as gaseous reactants, is fed into the bottom of the reactor 12 through the gas inlet 14, the gas typically being uniformly distributed through a sparger system (not shown) inside the reactor 12. Simultaneously, a recycle gas stream (typically cooled) comprising typically hydrogen, carbon monoxide, methane and carbon dioxide is returned to the reactor 12 through the recycle gas stream line 24.

The gaseous reactants, comprising the fresh synthesis gas and the recycled gas, pass upwardly through a slurry bed 40 comprising Fischer-Tropsch catalyst particles, typically an iron or cobalt-based catalyst, suspended in liquid product. The slurry bed 40 is operated to have a normal level 42 above the upper open ends 32.2 of the inner conduits 28.1. A head space 44 is provided above the slurry bed 40. As the synthesis gas bubbles through the slurry bed 40, the gaseous reactants therein react catalytically and exothermically to form liquid product, which thus forms part of the slurry bed 40, and gaseous product. From time to time, or continuously, liquid phase or slurry comprising liquid product is withdrawn through the outlet 18, with catalyst particles being separated from the liquid product in a suitable internal or external separation system, e.g. using filters (not shown). If the separation system is located externally to the reactor 12, an additional system (not shown) to return the separated catalyst particles to the reactor 12 is then provided.

The fresh synthesis feed gas and the recycled gas are introduced into the reactor 12 at a rate sufficient to agitate and suspend all of the catalyst particles in the system without settling. The gas flow rate will be selected depending on the slurry concentration, catalyst density, suspending medium density and viscosity, and particular particle size used. Suitable gas flow rates include, for example, from about 5 cm/s to about 50 cm/s. However, gas velocities up to about 85 cm/s have been tested in bubble columns. The use of higher gas velocities has the disadvantage that it is accompanied by a higher gas hold-up in the reactor leaving relatively less space to accommodate the catalyst-containing slurry. Whatever gas flow rate is however selected, it should be sufficient to avoid particle settling and agglomeration.

Some slurry continuously passes downwardly through the downcomers (not shown) thereby to achieve uniform redistribution of catalyst particles within the slurry bed 40 and also to ensure uniform heat redistribution throughout the slurry bed 40.

The reactor 12 is operated so that the slurry bed 40 thereof is in a heterogeneous or churn-turbulent flow regime and comprises a dilute phase consisting of fast-rising larger bubbles of gaseous reactants and gaseous product which traverse the slurry bed virtually in plug flow fashion and a dense phase which comprises liquid product, solid catalyst particles and entrained smaller bubbles of gaseous reactants and gaseous product.

As can be clearly seen in FIGS. 2 and 3, the slurry bed 40 surrounds the outer or jacket conduits 28.2 and also occupies or fills the inner conduits 28.1. Thus, the slurry bed 40 is in contact with an inner circular cylindrical surface of each inner conduit 28.1 and also in contact with an outer circular cylindrical surface of each outer or jacket conduit 28.2. These surfaces act as heat transfer surfaces. Boiler feed water, as a heat exchange or transfer medium, is circulated through the jacket spaces 30. The boiler feed water enters the jacket spaces 30 by means of the boiler feed water inlet 36 and the conduits 34 and flows upwardly through the jacket spaces 30 as indicated by arrows 42 before leaving the reactor 12 through the conduits 34 at the upper ends of the jacketed conduits 28 and the boiler feed water outlet 38. Heat is thus transferred from the slurry bed 40 to the boiler feed water to form a mixture of steam and water.

Light hydrocarbon products, such as a C₂₀ and below fraction is withdrawn from the reactor through the gas outlet 16 and passed to the separation unit 20. Typically, the separation unit 20 comprises a series of coolers and a vapour-liquid separator and may optionally include further coolers and separators and possibly also a cryogenic unit for removal of hydrogen, carbon monoxide, methane and carbon dioxide from the C₂₀ and below hydrocarbon fraction. Other separation technologies such as membrane units, pressure swing adsorption units and/or units for the selective removal of carbon dioxide may be employed. The separated gases comprising nitrogen, carbon monoxide and other gases are compressed and recycled by means of the compressor 22 to provide the recycle gas stream. Condensed liquid hydrocarbons and reaction water are withdrawn from the separation unit 20 by means of a flow line 44 for further working up.

It is to be appreciated that, although the installation 10, as illustrated, indicates that a recycle gas stream is returned to the reactor 12, it is not necessarily so that a recycle gas stream will be employed. It is also to be appreciated that the reactor 12 may include jacketed conduits 28 which are grouped in bundles, with the bundles then being vertically spaced. An intermediate zone may thus be defined between the bundles. Advantageously, at least a portion of the recycle gas stream may then be introduced into the intermediate zone, between the bundles of jacketed conduits 28, so that said portion of the recycle gas stream bypasses the jacketed conduits 28 of the lower bundle.

It is an advantage of the invention, as illustrated, that heat removal capacity in the slurry bubble column is increased in an elegant and cost effective way. Compared to a conventional cooling coil, a vertically extended jacketed conduit such as a conduit 28, with the cooling medium in the jacket space, substantially increases the heat transfer surface area available per unit length of conduit.

1. A process for producing liquid and, optionally, gaseous products from gaseous reactants, the process including
feeding at a low level gaseous reactants into a vertically extending slurry bed of solid particles suspended in a suspension liquid, the slurry bed being located around a plurality of vertically extending jacketed conduits each comprising an inner conduit and an outer or jacket conduit defining between them a jacket space and the slurry bed also being located inside the inner conduits;
allowing the gaseous reactants to react exothermically as they pass upwardly through the slurry bed, thereby to form liquid and, optionally, gaseous products, and with the liquid product forming together with the suspension liquid, a liquid phase of the slurry bed, the reactions thus taking place outside the jacketed conduits and inside the inner conduits;
passing a cooling medium through the jacket space of the jacketed conduits thereby to remove reaction heat from the slurry bed;
allowing gaseous product and unreacted gaseous reactants to disengage from the slurry bed into a head space above the slurry bed;
withdrawing gaseous product and unreacted gaseous reactants from the head space; and
withdrawing liquid phase or slurry from the slurry bed, to maintain the slurry bed at a desired level.

2. The process as claimed in claim 1, in which the cooling medium is boiler feed water.

3. The process as claimed in claim 1, in which the inner conduits of the jacketed conduits are all open-ended, with at least the bottom open ends of the inner conduits being located within the slurry bed.

4. The process as claimed in claim 1, in which heat transfer surfaces defined by the jacketed conduits are shaped or textured to increase their heat transfer surface area or to improve heat transfer coefficients, compared to that obtained using smooth cylindrical surfaces only.

5. The process as claimed in claim 1, in which the solid particles are catalyst particles for catalyzing the reaction of the gaseous reactants into the liquid product and, when applicable, the gaseous product and in which the suspension liquid includes the liquid product.

6. The process as claimed in claim 5, which is a Fischer-Tropsch hydrocarbon synthesis process.

7. An installation for producing liquid and, optionally, gaseous products from gaseous reactants, the installation including
a reactor vessel having a vertically extending slurry bed zone which, in use, will contain a slurry bed of solid particles suspended in a suspension liquid;
a gas inlet in the vessel at a low level within the slurry bed zone, for introducing gaseous reactants into the vessel;
a gas outlet in the vessel above the slurry bed zone, for withdrawing gas from a head space above the slurry bed zone;
a liquid outlet in the vessel within the slurry bed zone, for withdrawing liquid product or slurry from the vessel; and
a plurality of vertically extending jacketed conduits in the slurry bed zone, each jacketed conduit comprising an inner conduit and an outer or jacket conduit defining between them a jacket space, the jacket space of at least some of the jacketed conduits being in flow communication to receive a common heat transfer fluid and to discharge the common heat transfer fluid, the inner conduits being open-ended in use to allow the slurry bed to occupy the inner conduits, and an external surface of the outer conduits being exposed to the slurry bed zone in use to be in contact with the slurry bed.

8. The installation as claimed in claim 7, in which bottom open ends of the inner conduits are located within the slurry bed zone.

9. The installation as claimed in claim 7, in which upper open ends of the inner conduits are located within the slurry bed zone.

10. The installation as claimed in claim 7, in which heat transfer surfaces defined by the jacketed conduits are shaped or textured to increase their heat transfer surface area or to improve heat transfer coefficients, compared to that obtained using smooth cylindrical surfaces only.

11. The installation as claimed in claim 7, in which the inner conduits have an inner diameter of at least about 5 cm, and the outer conduits have an outer diameter of at least about 7 cm.

12. The installation as claimed in claim 7, in which at least two bundles of jacketed conduits are positioned within the slurry bed, with the bundles being vertically spaced.

13. The installation as claimed in claim 7, in which the jacketed conduits, or the vertically spaced bundles of jacketed conduits when combined, have a length equal to at least about 50% of the height of the slurry bed zone.

14. The installation as claimed in claim 7, in which the jacketed conduits are arranged and dimensioned to provide between about 10 m² and about 50 m² of heat transfer surface area per m³ of slurry bed zone.

15. The installation as claimed in claim 7, in which the jacketed conduits each provide a heat transfer surface area of at least 0.38 m².
